(19) United States
(12) Patent Application Publication
(10) Pub. No.: US 2016/0005042 A1
(43) Pub. Date: Jan. 7, 2016

(54) HOST CARD EMULATION OUT-OF-BOUND DEVICE BINDING VERIFICATION

(71) Applicant: Mistral Mobile, Oulu (FI)

(72) Inventors: Timo P. Tervo, Oulu (FI); Ludwig Schulze, Forest Hills, NY (US)

(21) Appl. No.: 14/322,283

(22) Filed: Jul. 2, 2014

(51) Int. Cl. G06Q 20/40; H04L 29/06; H04W 4/14; G06Q 20/32; G06Q 20/38; H04L 9/32; G06Q 20/10

(52) U.S. Cl. CPC G06Q 20/4014; H04L 9/3234; H04L 63/0435; G06Q 20/10; G06Q 20/3278; G06Q 20/38215; H04W 4/14; G06Q 20/3829

(57) ABSTRACT

Methods and apparatus, including computer program products, are provided for mobile secure payments. In one aspect there is provided a method. The method may include sending, by a user equipment, verification information via an out-of-band channel to a host card emulation token provider, wherein the verification information includes one or more identifiers representative of the user equipment and/or user; and receiving one or more tokens, when the sent verification information verifies the identity of the user equipment and/or user. Related apparatus, systems, methods, and articles are also described.

### FIELD

The subject matter described herein relates to mobile payments.

### BACKGROUND

Host Card Emulation (HCE) provides a transfer of transaction information over a short-range wireless link. For example, a wireless device including a Near Field Communications (NFC) transceiver may approach a point-of-sale terminal (or other type of device) and transfer, via NFC, financial information (for example, personal account information, a token, and the like) to a point-of-sale system to complete a purchase. Rather than require a physical secure smart card, in HCE, a host processor, at the wireless device, emulates the smart card, so a separate, physical secure smart card may not be required in HCE. In some wireless devices, the operating systems may include HCE support, although HCE support may be provided by other types of applications as well.

### SUMMARY

Methods and apparatus, including computer program products, are provided for mobile secure payments.

In one aspect there is provided a method. The method may include sending, by a user equipment, verification information via an out-of-band channel to a host card emulation token provider, wherein the verification information includes one or more identifiers representative of the user equipment and/or user; and receiving one or more tokens, when the sent verification information verifies the identity of the user equipment and/or user.

In some variations, one or more of the features disclosed herein including one or more of the following features can optionally be included in any feasible combination. The out-of-band channel may be a short message service channel. The verification message may be encrypted before being sent. The encryption may include encrypting the verification information using a symmetric key formed by combining key values selected from a plurality of key collections. The user equipment may send a request for the one or more tokens, wherein the one or more tokens are received in response to the sent request. The user equipment may send registration information, wherein the registration information is sent in-band via an internet protocol communication to enable a comparison with the verification information sent out of band.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIG. 1 depicts an example system for out-of-band verification, in accordance with some example embodiments;

FIG. 2 depicts an example process for mobile terminal originated out-of-band verification, in accordance with some example embodiments;

FIG. 3 depicts an example process for token provider originated out-of-band verification, in accordance with some example embodiments;

FIG. 4 depicts an example block diagram of a radio, in accordance with some example embodiments;

FIG. 5 depicts an example process for encrypting messages, in accordance with some example embodiments; and

FIG. 6 depicts examples of key collections, key parts, symmetric keys, messages, and/or the like, in accordance with some example embodiments.

Like labels are used to refer to same or similar items in the drawings.

### DETAILED DESCRIPTION

Host Card Emulation (HCE) using tokens is rapidly surpassing NFC payment approaches having a physical, secure smart card element (also referred to as a secure element (SE)) and a trusted service manager (TSM). The HCE payment tokens may eliminate the need to transmit via NFC a personal account number (PAN) in less secure environments, such as mobile device to point-of-sale (POS) device transactions. These payment tokens may be used to execute transactions in a way that is similar to PAN-based transactions. Moreover, a payment network may be configured to determine that a given token number should be routed to an HCE token provider (for example, a source for the tokens). The token provider may provide de-tokenization by matching the token to the actual PAN, after which the PAN can be routed normally in a payment network to for example a bank, a credit card issuer, a mobile payment processor, a financial entity, and/or the like. The HCE token providers may be a variety of entities including issuers of tokens, processors of tokens, payment network providers, banks, financial institutions, credit card issuers, and/or any other type of provider.

The payment tokens transmitted via HCE may be scrambled, anonymized, or encrypted representations of the underlying PAN as well as other information, such as cardholder information. For example, the payment token may include a representation of the credit cardholder's zip code, name, PAN, and/or any other information.

HCE may not, as noted, require the use of a physical, secure hardware smart card or the use of any particular hardware security. This lack of a secure hardware element may be viewed as a vulnerability. For example, an attack on an IP (internet protocol) communication channel, the HCE application itself, or the user equipment hosting the HCE may all be sources of vulnerable from a security perspective.

In some example embodiments, the subject matter disclosed herein may provide an additional verification to confirm the legitimacy of a transaction between an HCE enabled user equipment (for example, a tablet, a cell phone, a smartphone, a POS terminal, and/or any other device) and an HCE token provider.

In some example embodiments, when (or if) the user equipment, IP communication channel, and/or HCE application is compromised by an attack, the subject matter disclosed herein may provide an additional level of verification. Moreover, this additional level of verification may be performed over an out-of-band communication channel, such as a secure channel including for example a short message service (SMS) channel. This secure out-of-band communication channel may provide verification information to the HCE token provider to enable the HCE token provider to authenticate the user equipment. In some example embodiments, the verification information carried via the SMS link may be encrypted. For example, an HCE application may request a token from the HCE token provider. To authenticate the user equipment or the user thereof, the HCE token provider may request verification information (which may be carried by the secure out-of-band SMS link and/or encrypted) from the HCE application at the user equipment before granting the requested HCE token.

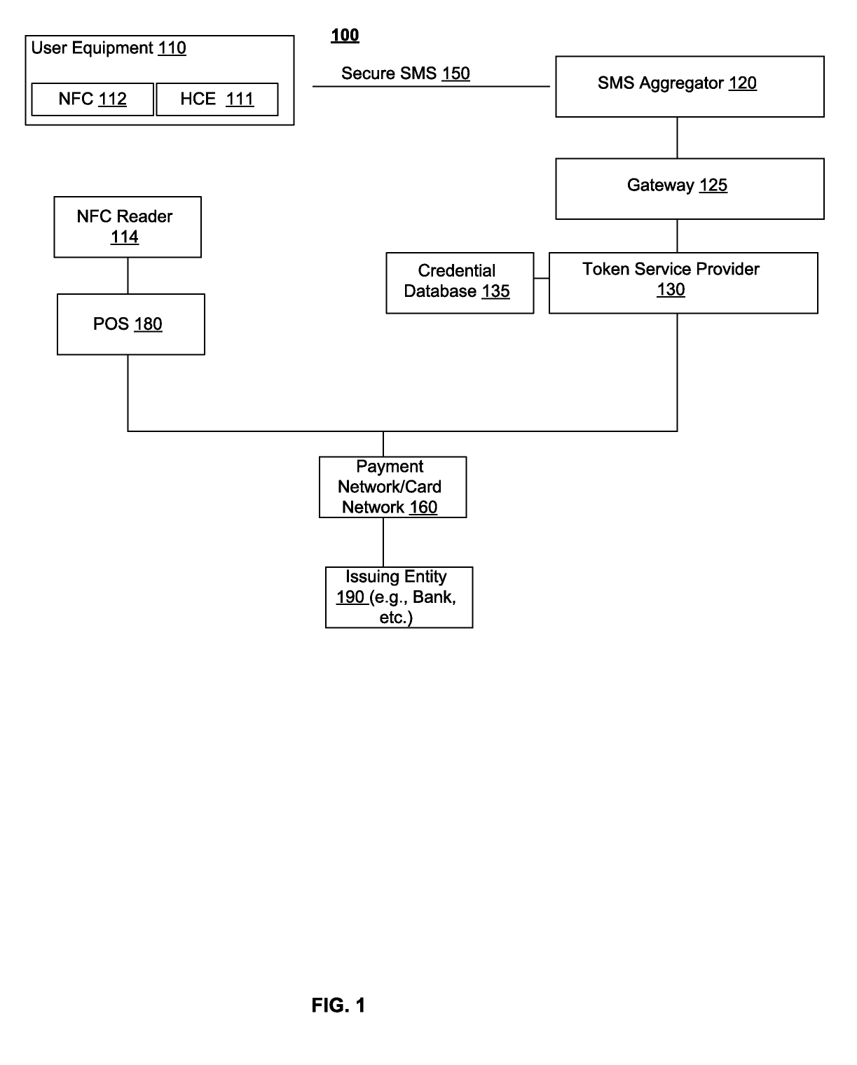

FIG. 1 depicts an example system 100, in accordance with some example embodiments.

The system 100 may include a user equipment 110, such as a cell phone, a smartphone, a tablet, and/or any other device including a short-range transceiver, such as NFC (although other radio technologies may be used as well). The user equipment 110 may further include an HCE application 111 and an NFC transceiver 112, which can be read by NFC reader 114. For example, HCE 111 may pass via NFC transceiver 112 a payment token to NFC reader 114 (which is coupled to, for example, a point-of-sale (POS) terminal) in order to initiate a financial transaction, such as make a purchase of an item, make a payment, purchase a ticket, and/or the like.

In some example embodiments, system 100 may further include an out-of-band channel 150 over which verification information may be shared with a token service provider 130. For example, one or more identifiers of the user equipment 110 may be sent via out-of-band channel 150 to token service provider 130. The one or more identifiers may include identifiers uniquely verifying the identity of user equipment 110 or its user.

The identifier(s) used to verify the user equipment and/or user of the equipment may include one or more of the following: a media access control (MAC) address of the user equipment, an IMSI (international mobile subscriber identity) of the user equipment, an IMEI (international mobile station equipment identifier) of the user equipment, an MEID (mobile equipment identifier) of the user equipment, an electronic serial numbers (ESNs), account identifiers (for example, GSM account information), a SIM (subscriber identity module) phone number, a platform identifier (for example, operating system identifier), a SIM serial number, and/or any other user equipment and/or SIM-based identifiers including a hash of one or more identifiers as well.

To illustrate by way of an example, user equipment 110 may share the identifiers via SMS link 150 and the identifiers may be encrypted before being carried via link 150. Specifically, user equipment 110 may encrypt one or more identifiers and then send them via SMS link 150 to gateway 125 via for example an SMS aggregator 120 or directly via an operator short message service center (SMSC). The gateway 125 may decrypt the identifiers (if encrypted) and then forward the decrypted identifier(s) to token service provider 130. Alternatively or additionally, the one or more individual identifiers may be hashed and then sent (for example, a hash of a combination of multiple identifiers). The HCE token provider 130 may then compare the identifier(s) received out-of-band via SMS with other information received in-band (for example, via other channels including other communications channels, such as an IP data channel, mobile data connections, card network 160, and the like). This other information may have been obtained during the registration of the user equipment and/or user thereof with for example the issuing entity 190, payment network 160, and/or token service provider 130, and then stored in a credential database 135 (although other information identifying the user/user equipment may be obtained in other ways as well including via in-person verification).

In some example embodiments, user equipment 110 may originate verification via out-of-band channel 150. For example, user equipment 110 may include an activated HCE application 111. As part of the initialization of this HCE application, information about the user equipment, such as identifiers for the user equipment 110, SIM-based identifiers, and/or the like, may be gathered and sent via for example an in-band communication channel (for example, via the Internet, IP channel, payment network 160, and/or the like) with the token service provider 130 and stored at for example database 135.

In some example embodiments, user equipment 110 may request one or more payment tokens. For example, user equipment 110 may send a request for a payment token to token provider 130 (although the token provider may push the token as well without an explicit request). This request may be sent in-band, although the request may also be sent via SMS link as well.

The token provider 130 may, before providing the payment token, determine whether additional verification is needed of the user equipment 110. For example, the token provider 130 may have a rule that requires verification based on the location of the user equipment 110, merchant type, type of transaction, amount of the token, speed or rate at which the tokens are being provided or depleted, established preferences (by a user or the token provider), issuing bank, and/or payment network (and/or other affiliated organizations such as EMV Co and/or acquiring banks and/or processors).

If verification of the user equipment 110 is required, the token provider 130 may request verification by sending a request for verification message to user equipment 110. The verification request may be sent in-band or out-of-band via an SMS link

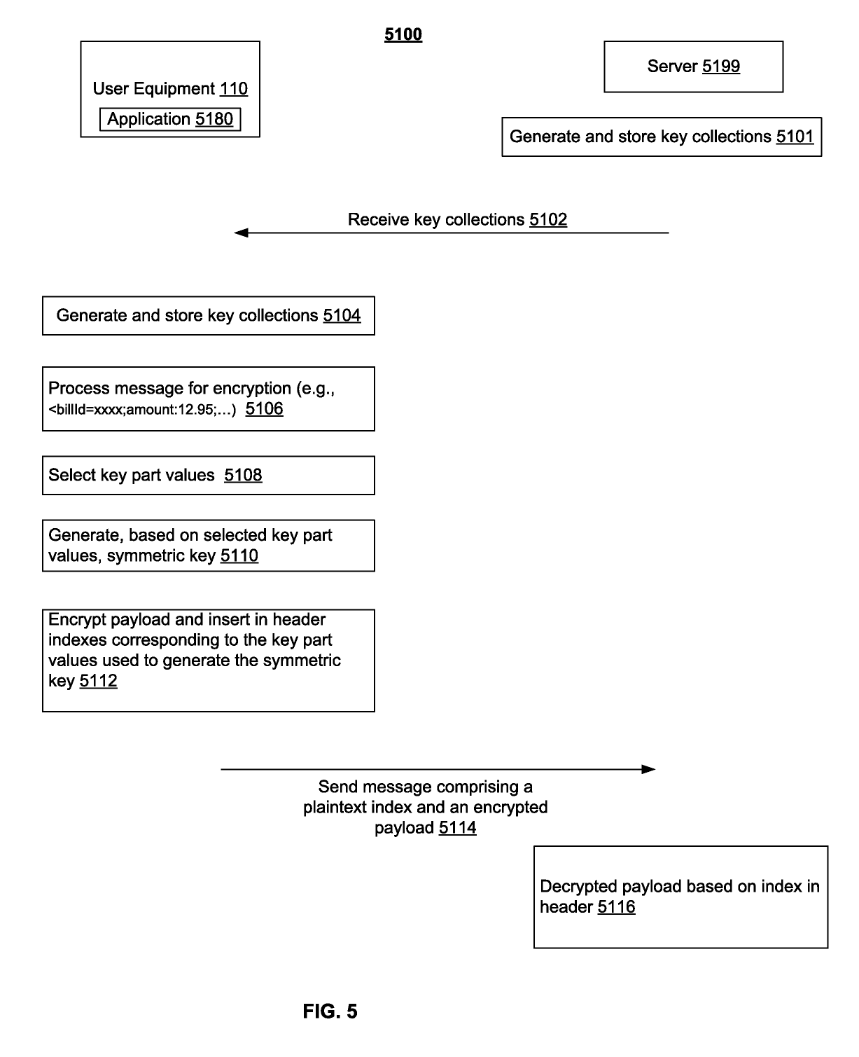

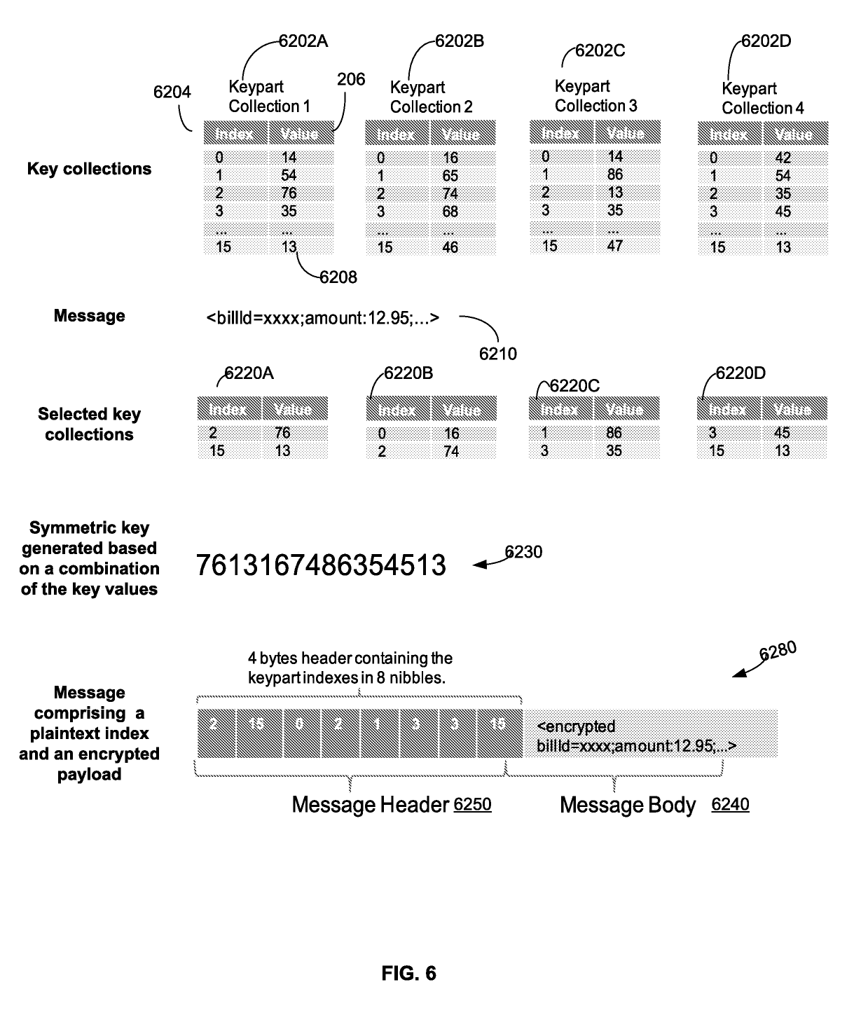

In response, user equipment 110 may provide via SMS channel 150 information to enable verification of the user equipment 110 and/or user of the user equipment. For example, the user equipment 110 may provide via SMS link 150 one or more identifiers for the user equipment and/or user thereof. Moreover, the one or more identifiers may be encrypted before being sent over SMS link 150. In some example embodiments, a symmetric encryption scheme is used as described further below with respect to FIGS. 5 and 6, although other encryption or security functions may be used as well.

The SMS message(s) including the one or more identifiers may be received by for example an SMS aggregator 120 (or SMSC) and forwarded to gateway 125, which may process the SMS message(s) by for example decrypting the SMS message including the identifiers. In some example embodiments, a symmetric decryption scheme is used as described further below with respect to FIGS. 5 and 6, although other decryption or security functions may be used as well. Moreover, encryption and/or decryption may not be used in some example embodiments. The gateway 125 may then forward the verification information (for example, the one or more identifiers and the like) to token service provider 130.

Token service provider may then compare the verification information/identifier(s) received via link 150 and gateway 125 to other verification information stored at database 135. For example, database 135 may include as noted above user and/or user equipment information obtained during the initial registration or initiation of the HCE service at user equipment 110.

If the comparison determines that the verification information received via link 150 and gateway 125 compares favorably to the other verification information stored at database 135, token service provider 130 may then proceed to replenish the HCE tokens. If not consistent, the token provider 130 may flag that additional review may be needed before providing a token (and/or not provide a token).

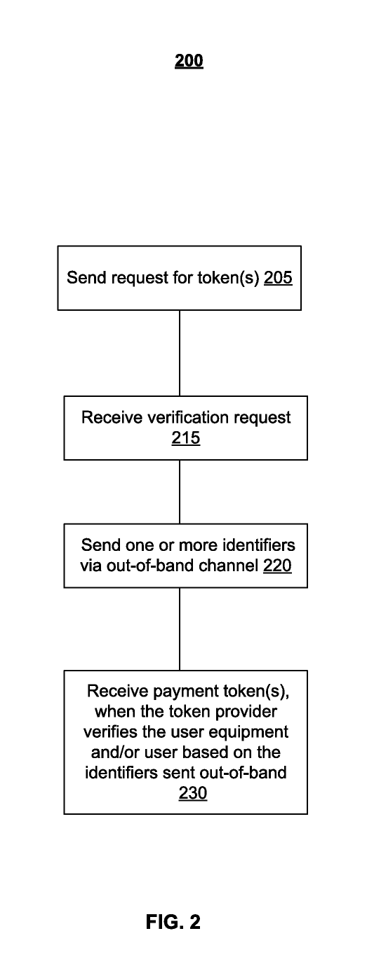

FIG. 2 depicts an example process 200 for out-of-band verification initiated by the user equipment, in accordance with some example embodiments. The description of FIG. 2 also refers to FIG. 1.

At 205, user equipment 110 requests one or more tokens to be provided by the token service provider 130. In response, the token service provider 130 may send a verification request, which may be received at 215 by user equipment 110. The user equipment 110 may then respond, at 220, to the verification request with one or more identifiers, and the response may be sent via SMS channel 150. Moreover, the one or more identifiers may be encrypted using for example symmetric encryption, although other encryption techniques may be used as well. When the network (for example, gateway 125) receives the encrypted identifiers, the identifiers are decrypted and then sent to the token service provider for verification as noted above (for example, identifiers may also combined and hashed with example a secure hash algorithm and/or the like).

If the verification of the out-of-band identifiers confirms the identity of the user equipment and/or user thereof, one or more tokens may be sent, so that once received, at 230, the user equipment 110 can proceed to utilize the tokens.

In some example embodiments, token provider 130 may originate the verification via the out-of-band channel 150. As in the previous example, the HCE application 111 may already be initialized and thus activated, so the token provider 130 may have obtained and stored (at for example database 135) information about the user and the corresponding user equipment. And, this information may include verification information, such as one or more identifiers for the user equipment and/or user. The token service provider may also verify by sending a request to the user equipment, and this request may include a unique ID that should be included as part of the verification response. This unique ID may be sent via an out-of-band connection with other identifiers.

In some example embodiments, user equipment 110 may request one or more payment tokens. For example, user equipment 110 may request a payment token from token provider 130 (although the token provider may push the token as well without an explicit request).

The token provider 130 may, before providing the payment token, determine whether additional verification is needed of the user equipment 110. For example, the token provider 130 may have a rule that requires verification based on the location of the user equipment 110, merchant type, type of transaction, amount of the token, speed or rate at which the tokens are being provided/depleted, and/or established preferences (by a user or the token provider).

The HCE token provider 130 may then send an encrypted SMS message (which may be encrypted by the gateway 125 or other device) to the user equipment 110 via SMS aggregator 120 (or SMSC) and SMS link 150. The message may be encrypted using a variety of techniques. However, in some example embodiments, the encryption is based on a symmetric unique key as described further below with respect to FIGS. 5 and 6 below. In some example embodiments, the encrypted message is a unique, random code, such as a 15-digit code and the like. The random code may be a random number generated by the token service provider, gateway, and/or the like, and this random number may be sent to the user equipment out-of-band inside the encrypted message so that the user equipment can decrypt and return the random number with other terminal identifiers.

When the user equipment 110 including HCE application 111 receives the message, the HCE application 111 may process the message by for example, decrypting the message. If symmetric unique key encryption is used, the decryption may be performed as described further below with respect to FIGS. 5 and 6.

The HCE application 111 may calculate a device hash by using identifier(s) collected from the user equipment and add an additional component to the hash, which is the unique random number, such as the 15-digit code noted above. The HCE application 111 may then encrypt the payload (using for example symmetric unique key encryption) and return the encrypted information back via a data connection, which is protected via SSL (secure session layer).

The gateway 125 may then decrypt the message and verify the message hash against stored user equipment identifier(s) and the previously shared unique code (for example, the 15-digit code). If the identifiers are consistent, HCE token provider 130 may proceed to provide (or replenish) one or more HCE tokens. If not consistent, the tokens may not be provided and an error may be issued to initiate additional review.

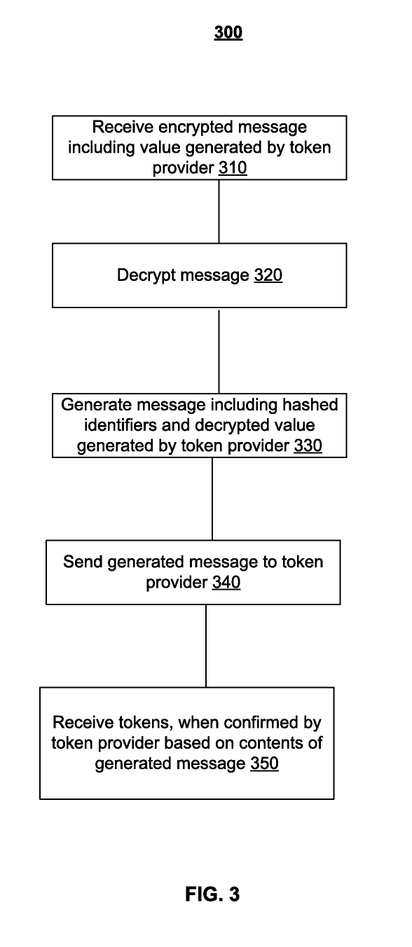

FIG. 3 depicts an example process 300 for token provider originated verification, in accordance with some example embodiments. The description of process 300 also refers to FIG. 1.

At 310, the token provider 130 may send to user equipment 110 a value, such as a 15-digit code. Moreover, this value may be encrypted and sent out-of-band via link 150 to user equipment 110. When user equipment 110 receives the encrypted message, user equipment 110 decrypts the message at 320. As noted, the encryption may be symmetric unique key encryption/decryption as described further below with respect to FIGS. 5 and 6 below, although other cryptographic techniques may be used as well. At 330, user equipment generates a message including the decrypted value generated by the token provider (for example, the unique 15-digit code) and one or more identifiers (which may be hashed). At 340, the user equipment may send the generated message to the token provider 130 via for example out-of-band link 150, although the message may be sent in-band as well to the token provider 130. When decrypted at the network, the token provider 130 may thus confirm the identity of the user equipment based on the one or more hashed identifiers (for example, by comparing the identifiers to stored information at 135 for the user equipment/user) and/or the value, such as the 15-digit value originally generated by token provider 130. If the comparison confirms the identity of the user equipment/user, the token provider may provide the token(s) to the user equipment at 350. If not, the token provider may inhibit sending the tokens until the identity of the user equipment/user can be confirmed.

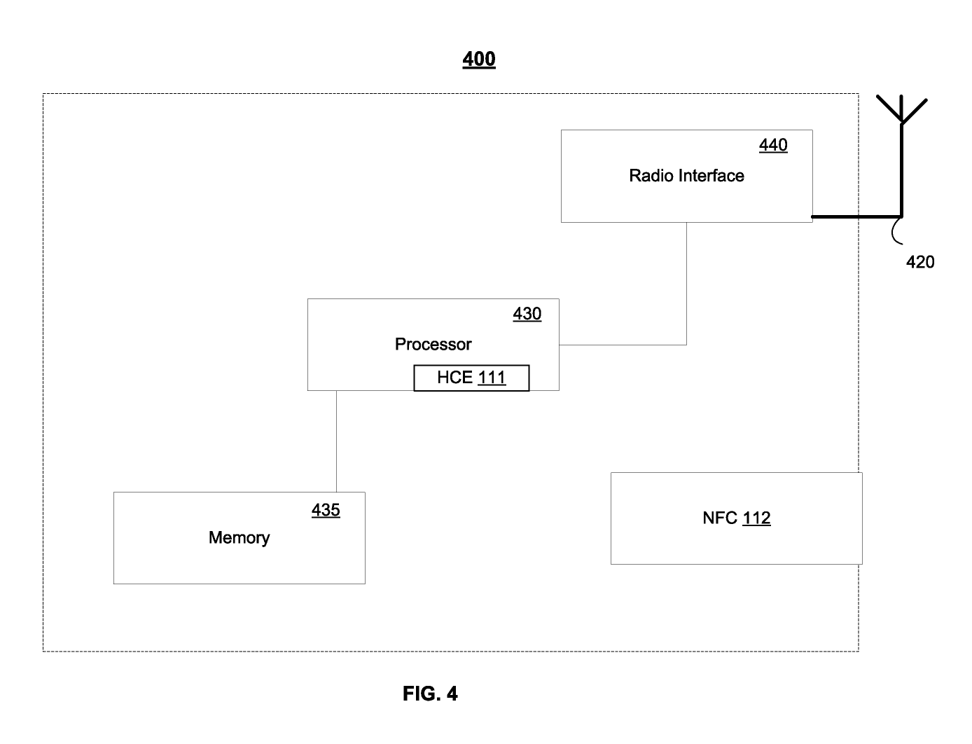

FIG. 4 depicts a block diagram of a radio 400, such as user equipment 110. The user equipment 110 may include an HFC application 111 and a short-range transceiver, such as NFC 112.

The user equipment may also include an antenna 420 for receiving a downlink and transmitting via an uplink. The user equipment 110 may also include a radio interface 440, which may include other components, such as filters, converters (e.g., digital-to-analog converters and/or the like), symbol demappers, signal shaping components, an Inverse Fast Fourier Transform (IFFT) module, and/or the like, to process symbols carried by a downlink or an uplink. In some implementations, the user equipment 110 may also be compatible with WiFi, Bluetooth, GERAN, UTRAN, E-UTRAN, first generation (1G) communication protocols, second generation (2G or 2.5G) communication protocols, third-generation (3G) communication protocols, fourth-generation (4G) communication protocols and/or any other standards, radio access technologies, and specifications as well. Moreover, the user equipment 110 may be configured to support messaging, such as SMS messages. The user equipment 110 may further include at least one data processor, such as data processor 430 (e.g., a microprocessor and/or the like) for controlling user equipment 110 and for accessing and executing program code stored in memory 435. For example, memory 435 may include code for performing one or more of the operations associated with the user equipment including process 200 and/or 300.

The following describes an encryption approach which may be used in some example embodiments. Specifically, a mobile application (for example, HCE application 111), may receive a key collection including a plurality of key parts from a server, such as gateway 125 and/or token provider 130. These key parts may include key values and indexes. A key value represents a portion of a symmetric key, and an associated index identifies the key value in a certain key collection. For example, when information is received for secure transmission by the mobile application 111 via link 150, the mobile application 111 may select 2 key parts (i.e., key values and corresponding indexes) from each of the 4 key collections, although other quantities of key values and key collections may be used as well. The mobile application 111 may then combine the selected key values to form a symmetric key, which is then used to encrypt the received information. The mobile application may then generate a short message service (SMS) message carrying at least a header portion and a payload portion. The payload may include the encrypted information, and the header may represent the indexes identifying which key values were selected to form the symmetric key. The mobile application may then send the SMS message to a server, where the SMS message is decrypted. In some example embodiments, the symmetric key is dynamically generated in the sense that each piece of information, such as financial transaction information, requiring transmission to the server is encrypted with a unique, one-time key. Moreover, the key collections at the mobile application may be updated with another key collection, when the possible key combinations have been exhausted, when the keys have been compromised, and/or any other time new key collections are desired. The subject matter disclosed herein may, in some example implementations, provide symmetric encryption for SMS communication and the like using a dynamic, one-time use symmetric key formed from key parts shared by the sender and receiver.

FIG. 5 depicts an example process 500 for providing secure transactions, in accordance with some example embodiments. The description of FIG. 5 also refers to FIG. 6.

In some exemplary embodiments, user equipment 110 may be implemented as a mobile wireless device. The user equipment 110 may be referred to as, for example, a mobile station, a mobile unit, a subscriber station, a wireless terminal, a tablet, a smartphone, a cell phone, and/or the like. The user equipment may be implemented as, for example, a wireless handheld device, a wireless plug-in accessory, and/or the like. In some cases, the user equipment may include a data processor, a computer-readable storage medium (e.g., memory, storage, and/or the like), a radio access mechanism, and/or a user interface. Moreover, the user equipment may include one or more applications, such as application 5180 stored as code in memory and executable by a data processor. Application 5180 may be implemented as HCE application 111 or as any other application as well. Furthermore, user equipment 110 may be configured to send SMS messages to SMS aggregator 120 (or SMSC) via a wireless access point, such as a base station, a WiFi access point, and/or the like, interfaced to the public land mobile network.

Server 199 may include a data processor and a computer-readable storage medium (e.g., memory, storage, and/or the like). In some example embodiments, server 199 may be implemented as gateway 125 having a first interface to a SMS aggregator 120 (and/or SMS provider) and a second interface to other systems, such as token provider 130. Although gateway 125 is depicted separate form token provider 130, in some example embodiments, the token provider 130 includes gateway 130 (and thus server 5199).

At 5101, the server 5199 may generate and store key collections. For example, server 199 may comprise a data processing device configured to generate key collections. Specifically, server 5199 may randomly generate and store key collections, each of which includes indexes and corresponding key values. The key values represent portions of a symmetric key, and when some of these portions are combined, the combined portions form a symmetric key used to encrypt information using a symmetric encryption engine, such as AES and/or the like. In some example embodiments, server 199 includes a security module that generates, or receives from a key generator, 4 key collections, as depicted at FIG. 6 (although other quantities may be used as well). These key collections may then be securely stored at server 5199.

The example of FIG. 6 depicts 4 key collections 6202A-D, and the key collections include indexes 6204 and key values 6206. Each of the indexes uniquely maps, and thus identifies, a certain key value. In some example embodiments, each of the key collections includes 16 key parts, each comprising an index and a key value. For example, these 16 key parts at key collection 6202A comprise index 0 and key value 14, index 1 and key value 54, index 2 and key value 54, and so forth through index 15 and corresponding key value 13. Moreover, any key value can be identified uniquely based on its collection and index. For example, key value 13 (at 6208) can be uniquely identified by specifying the key collection and index, which in this example is key collection 1 and index 15 (e.g. 1, 15). In any case, the key values can be combined by, for example, concatenating the key values to form a symmetric key as further described below. In some example embodiments, additional layers of security may be provided so long as both endpoints are aware of those additional layers to enable processing. For example, key values may be built in other ways from the shared key collection and index information so long as both endpoints are aware of the way being used.

Referring again to FIG. 5 at 5102, once the key collections are generated, server 199 may store the key collections in a secure manner, such as using a dedicated secure storage mechanism including, for example, a hardware security module (HSM), although other locations may be used as well.

At 5104, the server 5199 may send the key collections generated and stored at 5102 to user equipment 110. For example, server 5199 may share the key collections 6202A-D with user equipment 110 including mobile payment application 5180 by sending the key collections 6202A-D. In some example embodiments, the key collections may be sent via at least a wireless link carrying an encrypted SMS message as disclosed herein (e.g., an index and an encrypted payload, using for example AES, as disclosed herein), although the key collections may be sent in other ways as well. For example, when the client device, such as user equipment 110, connects to server 5199 for the first time, user equipment 110 may obtain the initial key collections (and/or other software and/or data for the application 5180) via a secure connection using, for example, using SSL or key collections can be shared by leveraging public-private key and temporary symmetric key approach. After that initial key collection delivery, the encrypted SMS messages disclosed herein may be used to share the key collections.

Once the user equipment 110 receives the key collections, user equipment 110 may then store at 5104 the key collections. Moreover, the application 5180 and/or user equipment 110 may receive key collections 6202A-D and then store the key collections 6202A-D securely using, for example, local encrypted, or otherwise secure, storage.

At 5106, a message may be processed for encryption, in accordance with some example embodiments. For example, mobile payment application 5180 and/or user equipment 110 may have a message for transmission, such as a bill pay message (“<billId=xxxx;amount:12.95>”) 210 at FIG. 6. In this example, the message represents a financial transaction to be carried by an SMS message securely, and, in particular, a user of user equipment 110 submitting bill payment to server 5199. As noted above, the encryption may be used in some example embodiments for out-of-band verification as disclosed herein.

At 5108, the application 5180 at user equipment 110 may select key parts. For example, application 5180 may randomly select 2 key parts from each collection, as depicted at 6220A-D at FIG. 6.

At 5110, a symmetric key may be generated, based on the selected key parts. For example, user equipment 110 and/or application 5180 may select the key values from each of the selected key parts 6220A-D and then combine those key values to form a symmetric key. Referring again to FIG. 6, the generated key is 7613167486354513 (at 6230). This generated key represents the concatenation of the selected key values, 76 and 13, from the first collection, the key values, 16 and 74, from the second collection, the key values, 86 and 35, from the third collection, and the key values, 45 and 13, from the fourth collection.

In some example embodiments, the generated symmetric key may also be hashed using user equipment 110's Mobile Station International Subscriber Directory Number (MSISDN), a Bluetooth universally unique identifier (UUID), or any other identifier (which would also be known by the server 5199), a media access control (MAC) address of the user equipment, an IMSI of the user equipment, an IMEI of the user equipment, an MEID of the user equipment, electronic serial numbers (ESNs), account identifiers (for example, GSM account information), a SIM phone number, platform identifier (for example, operating system identifier), SIM serial number, as well as any other user equipment and/or SIM-based identifiers including a hash of one or more identifiers.

At 5112, the symmetric key may be used to encrypt the message payload, and a plaintext header including indexes may be appended to the payload. For example, the message payload, “<billId=xxxx;amount:12.95>”, may be encrypted symmetrically using the key generated at 5110. The indexes for the selected key collections may then be combined and inserted into a header. This header may be in plaintext, i.e., not encrypted by the symmetric key. Referring again to FIG. 6, the message body 6240 includes the encrypted payload of “<billId=xxxx;amount:12.95>.” The message header 6250 includes the indexes for the selected key values contained in the symmetric key, so that the index uniquely identifies all of the key value pieces used to form the entire symmetric key 6230. For example, the message header 6230 includes indexes 2 and 15 from the first collection 6220A, indexes 0 and 2 from the second collection 220B, indexes 1 and 3 from the third collection 6220C, and indexes 3 and 15 from the fourth collection 6220D. Because the message header 6230 includes the ordered indexes from each key collection 6220A-D, the server 5199 will be able to determine symmetric key 6230 based on the plaintext index contained in the message header 6250. In some example embodiments, the symmetric encryption is AES, although other symmetric encryption techniques may be used as well.

Although the message header 6250 at FIG. 6 includes the indexes in a predetermined order corresponding to the collections 6202A-D, the indexes may be placed in the header in other orders as well. When this is the case, server 5199 may be configured to know the index placement technique used at the user equipment to access the key values in the key collections.

In some example embodiments, the message body 6240 may also be signed using, for example, a hash as noted above. This hash may be implemented as a Secure Hash Algorithm (SHA) and/or MD5, although other hash techniques may be used as well.

In the example of FIG. 6, as symmetric key creation relies on 4 key collections from which 2 key parts among 16 are randomly selected, the amount of unique combinations is 262,144 (i.e., 4 times 2¹⁶). Moreover, the header 6250 may, in some example embodiments, contains 4 bytes reserved to receive the 8 indexes of the key parts necessary to re-generate the symmetric key for decrypting the message body 240. Each of these indexes fit into one nibble (i.e., a half-byte whose value is between 0-15), so the 8 indexes of the key parts can be set using only 4 bytes (i.e., 8×½ byte). Although some of the examples described herein refer to specific quantities of key values, key collections, and indexes, other quantities may be implemented as well.

At 5114, the message may be sent to server 5199. Referring again to FIG. 6, user equipment 110 may send message 6280 including message header 6250 and message body 6240 to server 5199. Moreover, message 6280 may be sent via SMS or any other connectivity channel between client and server. Specifically, user equipment 110 may provide message 6280 to an SMS interface at the user equipment 110 for sending the message 6280 via SMS. The server 5199 may have an interface to an SMS provider, which provides the SMS message 6280 to server 5199. In this example, the server 5199 may obtain the user equipment's MSISDN from the SMS service provider and determine the key parts used based on the header 250 carried by the SMS message.

At 5116, server 5199 may decrypt the message based on the index in the header. For example, server 5199 may read the header comprising 2, 15, 0, 2, 1, 3, 3, and 15 and then access the key collections to identify the key values forming the symmetric key (e.g., 7613167486354513) used by user equipment 110 to send the message. Using the symmetric key, server 5199 may then decrypt the message into plaintext. When hashing is used, the server 5199 may hash the symmetric key before decrypting the message.

In some example embodiments, the server 199 may send an acknowledgement message to user equipment 110 to confirm receipt of the message received by server 5199 at 110. This acknowledgement may be sent as an SMS message. Moreover, this SMS acknowledgement message may carry a payload encrypted using the same key used to encrypt the payload of the message received at 114, although a different key may be generated using the key collections.

In some example embodiments, each generated symmetric key is used only during one request/response sequence before it is discarded. When this is the case, the user equipment 110 may store and keep a record of all the used key parts combinations. Moreover, the record may allow server 5199 to reject any incoming messages that use an already-used symmetric key. Furthermore, once a certain amount of key parts combinations have been used or when the key collections (or portions thereof) have been compromised, server 199 may, in some example embodiments, decide to renew the key collections by resending a new set of key collections at 5102.

The subject matter described herein may be embodied in systems, apparatus, methods, and/or articles depending on the desired configuration. For example, the base stations and user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “machine-readable medium” refers to any computer program product, computer-readable medium, computer-readable storage medium, apparatus and/or device (e.g., magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. Moreover, the implementations described above may be directed to various combinations and subcombinations of the disclosed features and/or combinations and subcombinations of several further features disclosed above. In addition, the logic flow depicted in the accompanying figures and/or described herein does not require the particular order shown, or sequential order, to achieve desirable results. Other embodiments may be within the scope of the following claims.

What is claimed:

1. A method comprising:
sending, by a user equipment, verification information via an out-of-band channel to a host card emulation token provider, wherein the verification information includes one or more identifiers representative of the user equipment and/or user; and
receiving one or more tokens, when the sent verification information verifies the identity of the user equipment and/or user.

2. The method of claim 1, wherein the out-of-band channel is a short message service channel.

3. The method of claim 1, wherein the verification message is encrypted before being sent.

4. The method of claim 3, wherein the encryption comprises encrypting the verification information using a symmetric key formed by combining key values selected from a plurality of key collections.

5. The method of claim 1 further comprising:
sending, by the user equipment, a request for the one or more tokens, wherein the one or more tokens are received in response to the sent request.

6. The method of claim 1 further comprising:
sending, by the user equipment, registration information, wherein the registration information is sent in-band via an internet protocol communication to enable a comparison with the verification information sent out of band.

7. An apparatus comprising:
at least one processor; and
at least one memory including program code which when executed by the at least one processor causes operations comprising:
sending, by apparatus, verification information via an out-of-band channel to a host card emulation token provider, wherein the verification information includes one or more identifiers representative of the apparatus and/or user; and
receiving one or more tokens, when the sent verification information verifies the identity of the apparatus and/or user.

8. The apparatus of claim 7, wherein the out-of-band channel is a short message service channel.

9. The apparatus of claim 7, wherein the verification message is encrypted before being sent.

10. The apparatus of claim 9, wherein the encryption comprises encrypting the verification information using a symmetric key formed by combining key values selected from a plurality of key collections.

11. The apparatus of claim 7 further comprising:
sending, by the apparatus, a request for the one or more tokens, wherein the one or more tokens are received in response to the sent request.

12. The apparatus of claim 7 further comprising:
sending, by the apparatus, registration information, wherein the registration information is sent in-band via an internet protocol communication to enable a comparison with the verification information sent out of band.

13. A non-transitory computer-readable storage medium including program code which when executed by at least one processor causes operations comprising:
sending, by a user equipment, verification information via an out-of-band channel to a host card emulation token provider, wherein the verification information includes one or more identifiers representative of the user equipment and/or user; and
receiving one or more tokens, when the sent verification information verifies the identity of the user equipment and/or user.

14. A method comprising:
receiving, at a host card emulation token provider, verification information via an out-of-band channel, wherein the verification information includes one or more identifiers representative of a user equipment and/or user; and
sending, by the host card emulation token provider, one or more tokens, when the sent verification information verifies the identity of the user equipment and/or user.

15. The method of claim 14 further comprising:
sending, by the host card emulation token provider, a verification request to the user equipment, wherein the request includes a random code.

16. The method of claim 15, wherein the received verification information is in response to the verification request, wherein the received verification information includes the random code returned by the user equipment.

17. An apparatus comprising:
at least one processor; and
at least one memory including program code which when executed by the at least one processor causes operations comprising:
receiving, at the apparatus, verification information via an out-of-band channel, wherein the verification information includes one or more identifiers representative of a user equipment and/or user; and
sending, by the apparatus, one or more tokens, when the sent verification information verifies the identity of the user equipment and/or user.

18. The apparatus of claim 17 further comprising:
sending, by the apparatus, a verification request to the user equipment, wherein the request includes a random code.

19. The apparatus of claim 17, wherein the received verification information is in response to the verification request, wherein the received verification information includes the random code returned by the user equipment.

20. A non-transitory computer-readable storage medium including program code which when executed by at least one processor causes operations comprising:
receiving, at the apparatus, verification information via an out-of-band channel, wherein the verification information includes one or more identifiers representative of a user equipment and/or user; and
sending, by the apparatus, one or more tokens, when the sent verification information verifies the identity of the user equipment and/or user.
